(19) United States
(12) Patent Application Publication
(10) Pub. No.: US 2004/0143828 A1
(43) Pub. Date: Jul. 22, 2004

(54) FIRMWARE UPDATING METHOD AND RELATED APPARATUS FOR CHECKING CONTENT OF REPLACING FIRMWARE BEFORE FIRMWARE UPDATING

(76) Inventors: Tun-Hsing Liu, Yun-Lin Hsien (TW); Yuan-Ting Wu, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,560

(22) Filed: Oct. 8, 2003

(30) Foreign Application Priority Data
Jan. 20, 2003 (TW) 092101069

(51) Int. Cl. G06F 9/44

(52) U.S. Cl. 717/168; 717/120

(57) ABSTRACT

A method and related apparatus used for updating the firmware of an electronic system. The electronic system includes a host device and a peripheral device. The device has a control circuit and a flash memory for storing a first firmware code. The control circuit executes the first firmware code to control the device according to the control commands from the host. The method includes a checking step to check if the content of the second firmware code matches a predetermined content to ensure compatibility of the second firmware code before replacing/updating the first firmware code with a second firmware code. The checking step could be performed by the host and/or by the control circuit. The checking step is performed to check if values/strings of constants defined in the second firmware code match predetermined values/strings, and/or to check whether commands/information in predetermined addresses of the second firmware code match predetermined commands/information.

### BACKGROUND OF INVENTION

1. Field of the Invention

The invention relates to a firmware updating method and related apparatus and more particularly, to a method and apparatus for checking content of replacing firmware before firmware updating to ensure compatibility.

2. Description of the Prior Art

In modern information society, information, images and data are transferred, stored, and processed digitally. Various electronic systems and devices, from mobile phones to computers used for accessing digital signals, have become the key foundation of information construction. In general, most electronic devices have a control circuit for controlling operations. In the case of multi-functional or complex devices, the processor needs a program code to specify related steps and control procedures due to the control procedures being more complex. The control circuit executes this program code to implement different functions of the electronic device. This program code is referred to as firmware code and is often stored in a non-volatile memory (flash memory for example) in order that the control circuit can read and execute it more efficiently. Additionally, in more complex electronic systems such as computers, peripheral devices have their own control circuit and corresponding firmware code. The host only needs to send higher-level control commands to the control circuit of the peripheral device, which executes its own firmware code to control operations of the peripheral device. For example, an optical disk drive of a computer system has a control circuit and corresponding flash memory to store the firmware code. When the host wants to retrieve data stored on an optical disk, it just needs to indicate the data address to optical disk drive and the control circuit of the optical disk drive executes its own firmware code to coordinate the operations of the spindle, pick-up head and other components (such as requiring the spindle to reach a specific rotation rate and requiring the pick-up head to execute track seeking and track locking to a specific position to receive the reflection laser from the optical disk).

Please refer to FIG. 1. FIG. 1 is a function block diagram of a typical electronic device 10. The electronic device 10 can be in a computer system, it comprises a host 10 and at least a peripheral device. Two peripheral devices 14, 15 are shown in FIG. 1 as example. The peripheral device can be in an optical disk drive, a CD recorder, a hard drive, an external flash memory and so on. Using the peripheral device 14 as an example, the peripheral device 14 has a control circuit 16, a buffer memory 18, a storage memory 20 and servo hardware 22. If the electronic device 10 is a computer system, the typical configuration of the host 12 is shown in FIG. 1. The host 12 has a CPU 26, a north bridge circuit 28A, a south bridge circuit 28B, a non-volatile memory 30, a graphics card 32A and a monitor 32B. The CPU 26 is used for controlling the operations of the host 12. The memory 30 is used for temporarily storing required data of the CPU 26. The graphics card 32A is used for processing image signals to transform the operational situation of the host 12 into an image on the monitor 32B. The north bridge circuit 28A is used for controlling the data transfer between the graphics card 32A, the memory 30, and the CPU 26. The south bridge circuit 28B is electrically connected to the CPU 26 via the north bridge circuit 28A. The peripheral devices 14 and 15 exchange instructions and data with the host 12 via the connection (such as via the IDE bus) with the south bridge circuit 28B. On the other hand, on the peripheral device 14, the control circuit 16 is used for receiving controlling instructions from the host 12 to control the operations of the peripheral device 14. The servo hardware 33 is controlled by the control circuit 16 to implement functions of the peripheral device 14. For example, if the peripheral device 14 is an optical disk drive, the servo hardware 22 includes a spindle for rotating an optical disk, a pick-up head and other electronic components needed for accessing data on an optical disk. The buffer memory 18 and storage memory 20 are used for supporting the operations of the control circuit 16, wherein the buffer memory 18 is a volatile memory (such as RAM) for temporarily storing required data of the control circuit 16. The storage memory 20 is a non-volatile memory (such as flash memory) for recording a program code 24 of a firmware. As mentioned above, when the control circuit 16 controls the peripheral device 14, it follows specific firmware code to execute various control procedure and the program code 24 is the firmware code for recording the steps of various control procedures. The control circuit 16 executes the program code 24 to control the operations of the peripheral device 14 according to the control instructions from the host 12.

Of course, when each peripheral device is produced, the storage memory installs a firmware code to be the pre-set firmware. After the peripheral device connects to the host, the control circuit of the peripheral device controls the operations of the peripheral device according to the pre-set firmware. However, some bugs of control procedure of the pre-set firmware may be found after the device leaves the factory. Additionally, the firmware developing firms continue to develop new control procedures and firmware codes to upgrade performance of the peripheral device or to extend the application of the peripheral device. For example, an optical disk drive may be capable of locking the laser pick-up head faster and retrieving specific data from an optical disk more stable by adopting different control procedures. Perhaps some optical disks adopt a new data format standard to record data and optical disk drives can read the new format optical disk by updating parts of the control procedure of firmware code to extend the supported data format of optical disks. As discussed above, updating the firmware code of a peripheral device is needed for solving errors in the pre-set firmware code, upgrading performance of the peripheral device or extending the application scope of the peripheral device by replacing the firmware code of the peripheral device with a new firmware code. In modern peripheral devices, the firmware code is often stored in re-write-able non-volatile memory (such as a flash memory or a EEPROM). In order to update firmware by replacing the old pre-set firmware code with a new firmware code, it only needs to erase the pre-set firmware code in the storage memory and write in a new firmware code. The control circuit of the peripheral device executes the new firmware code stored in storage memory for using new control procedures to control the operations of the peripheral device.

In generally, when updates the firmware code of the peripheral device, the host also needs to execute corresponding operations. Please refer to FIG. 2, as well as to FIG. 1. A flowchart 100 of FIG. 2 is a cooperation flow between the host 12 and the peripheral device 14 when the electronic system 10 updates the firmware of the peripheral device 14 in the prior art. The host 12 executes the steps on the left half of FIG. 2 and the peripheral device 14 executes the steps on the right half of FIG. 2. With regard to the prior art the flow 100 comprises the following steps in sequence:

Step 102: Start. When the firmware code of the peripheral device 14 is updated, the CPU 26 executes a firmware updating application program 34 to start the firmware updating flow 100 and continues to control the firmware updating flow with the following steps. As shown in FIG. 1, the application program 34 is being loaded into the memory 30 of the host 12 and the CPU 26 executes the application program 34 to update the firmware of the peripheral device 14 by replacing the program code 24 of the peripheral device 14 with a new program code 36.

Step 104: When the host executes the application program 34, it identifies the peripheral device 14 first to ensure that the application program 34 corresponds with the peripheral device 14 and controls the peripheral device 14 to update the firmware correctly. As mentioned above, the host 12 connects with a plurality of different peripheral devices and each of the peripheral devices has different structures and functions. In order to control different peripheral devices to update firmware respectively, the host 12 needs to execute corresponding application programs. This step is to ensure that the application program 34 corresponds with the peripheral device 14. In generally, the firmware code of each peripheral device has recorded firmware identification, comprising a vendor ID, model names of peripheral devices supported by the firmware code or versions of the firmware code etc. For example, the program code 24 of the peripheral device 14 records a firmware identification code 241. When the host 12 executes the application program 34, it sends a control command of device identification to the peripheral device 14 according to the application program 34 for requesting that the peripheral device 14 transmits the related information of the firmware identification code 241 (or other data and signal which capable of identifying the peripheral device 14) to the host 12.

Step 106: The peripheral device 14 responses the request from the host 12 of the step 104, and transmits the related data of the firmware identification code 241 (or other identification data) to the host 12.

Step 108: When the host 12 executes the application program 34, it determines if the peripheral device 14 corresponds to the application program 34 according to the identification data returned form the peripheral device 14. In fact, when the host 12 executes the identification inspection of the peripheral device 14, it probably executes several times data and instruction exchange. For brevity, the flowchart of FIG. 2 simplifies the detail of device identification. According to the data exchange between the peripheral device 14 and the host 12, if the host determines that the application program 34 corresponds with the peripheral device 14, the host 12 is capable to continue to execute the firmware updating flow and send a control instruction to inquire if the operational state of the peripheral device 14 is capable to execute firmware updating. Because, when the host 12 executes the application program 34 in order to update the firmware, the peripheral device 14 may execute some operations (such as the peripheral device 14 of an optical disk drive which accesses data on an optical disk), so that it will not be capable of executing firmware updates. That is why the host 12 needs to inquire the operational state of the peripheral device 14. At the same time the host 12 loads the new program code 36, used for updating firmware into the memory 30, to prepare transmitting to the peripheral device 14.

Step 110: The peripheral device 14 responses to the inquiry from the host and transmits the operational state to the host 12.

Step 112: If the operational state returns from the peripheral device 14, it shows that the peripheral device is capable of updating the firmware. The host 12 transmits the new program code 36, which is temporarily stored in memory 30, to the peripheral device 14. As well as a typical network transmission, when the host 12 transmits the new program code 36, it also executes a default check-sum-generation algorithm to generate a checksum 36C according to the content of the new program code 36, the checksum 36C and the new program code 36 is then transmitted to the peripheral device 14.

Step 114: The peripheral device 14 receives the new program code and the checksum from the host 12 is temporarily stored in the buffer memory 18. The new program code 37 and checksum 37C are temporarily stored in the buffer memory 18 of the peripheral device 14 in FIG. 2. These are received from the host 12 by the peripheral device 14.

Step 116: The control circuit also executes the checksum-generation algorithm for generating another checksum 39C according to the received new program code 37 and compares the checksum 39C and the checksum 37C transmitted from the host 12. The two checksum-generation algorithms respectively used in the control circuit 16 and the host 12 are identical. If a new program code and checksum is being transmitted from the host 12 to the peripheral device 14 without any error of data transmission, the new program code 37 received by the peripheral device 14 should be equal to the new program code 36 which the host 12 needs to transmit, and the checksum 39C generated by the control circuit 16 should equal the received checksum 37C. On the other hand, if the check-sum 39C generated by the control circuit 16 is not equal to the received checksum, 37C represents that error of data transmission when the host 12 transmits the new program code/checksum to the peripheral device 14. If checksum 39C is identical with the checksum 37C, it should go to step 118; otherwise it should go to step 120.

Step 118: In the prior art, after the control circuit 16 confirms the new program code 37 in step 116, it erases the program code 24 stored in the storage memory 20 and writes the new program code 37 temporarily stored in the buffer memory 18 into the storage memory 20 and thereby completes the firmware update of the peripheral device 14. Next the control circuit 16 executes the new program code 37, which is written into the storage memory 20, to control operations of the peripheral device 14. Of course, after the firmware is updated, the peripheral device 14 can send the result to the host 12; the host 12 can again request the peripheral device 14 to transmit the firmware identification of the new program code to the host 12 for confirmation.

Step 120: If the control circuit 16 compares the checksums 37C and 39C in step 116, and the result is contradiction, it executes necessary error handling. For example, the control circuit 16 can request the host 12 to retransmit the new program code 36 and proceeds checksum compare of the step 116 again, or return the error situation to the host 12 for determining following operations.

Step 122: The firmware updating flow ends.

In summary, when the firmware is updated according to the flow 100 of the prior art, the host 12 inspects with the peripheral device 14. After it confirms that the peripheral device 14 can proceed firmware updating, the host 12 just transmits the new program code 36 to the peripheral device 14 to update the firmware. In step 116, the peripheral device 14 compares the two checksums to confirm the new program code. The peripheral device 14 executes firmware updating after confirming the new program code without any error. A major drawback of the above-mentioned prior art is that it is not capable of ensuring the content of the new program code for firmware updating if it conforms to the peripheral device 14. In general, the new program code 36 retrieved by the user of the host 12 (like downloaded from internet) and the application program 34 loads the program code 36 into the memory 30 of the host 12 during the firmware updating process. When the user retrieves the new program code 36 and possibly encounters a mistake, which results in the new program code 36 not conforming to the peripheral device 14. For example, the user of the host 12 downloads the new program code 36 from the Internet with some transmission errors. This results in the new program code 36 being incomplete or the user chooses a wrong version program code. As mentioned above, the firmware vendor may continuously release a new version firmware code. Lets assume the peripheral device 14 has a new version of firmware code and the user is not aware of that the user wants to update the firmware of the peripheral device 14 with an older version program code 36. In such a situation, the version of the existing program code 24 is newer than the program code 36. If the firmware is updated at this time, the firmware will actually downgrade. Additionally, the user may get a wrong firmware code as the new program code 36. Especially with rapidly developing techniques, peripheral devices of different models and different functions may possibly be announced by the same firm. Optical disk drives, is a common device of a computer system and therefore there are various types. These various optical disk drivers have different access speeds, some of them can only retrieve data from optical disks, some of them can write data into optical disks, and some of them support different data formats. The firmware vendor releases different firmware codes for updating different types of peripheral devices, but the user may not be aware of that and get a wrong program code 36 to update the peripheral device 14. Furthermore, someone may purposely provide a wrong firmware code as the new program code 36. The purpose of this would be to crash the peripheral device 14 by embedding the wrong program code into the peripheral device through a firmware update.

In the above-mentioned situation, the new program code 36 used by the host 12 to update the firmware is not conformed to the peripheral device 14. This cannot be found in the prior art firmware updating process. In the prior art, the host 12 identifies the device in step 104 by checking the firmware identification code 241 of the existing program code 24 with the peripheral device 14. The host 12 only checks the firmware code used by the peripheral device 14 (and the existed program code 24 of the peripheral device 14) if the program code 36 conforms to the peripheral device 14. Additionally, the control circuit 16 of the peripheral device 14 checks the checksum of the new program code 36 in step 116, but this step can only find out errors of the new program code 36 if it occurs in the transmission between the host 12 and the peripheral device 14 and cannot examine whether the new program code 36 is suitable. Even though the new program code is not suitable, if no error of the new program code occurs in transmission between the host 12 and the peripheral device 14, step 116 writes the new program code into the storage memory. In other words, in step 116, even if the checksum is confirmed, it only means the host 12 transmits the unsuitable new program code 36 to the peripheral device 14 to become the new program code 37 (seeing the FIG. 2) without errors, but this does not change the new program code 37 from unsuitable to suitable. Although the control circuit 16 generates the checksum 39C according to the new program code 37 in step 116 so that the checksum 39C can reflect the content of the new program code 37, another checksum 37C used to confirm the checksum 39C is generated and based on the new program code 36. However, this does not represent a proper checksum of the suitable firmware code. Especially, if at the time the new program code 36 does not have a suitable firmware code. In other words, according to step 116 of the prior art flow 100, the control circuit 16 does not know what checksum corresponds to the suitable firmware code and of course it is not possible to find out if the new program code 37 is suitable or not. When writing a wrong or unsuitable firmware code into the peripheral device 14 in the firmware updating flow, it not only cannot implement a firmware update, but also causes the peripheral device 14 to malfunction.

### SUMMARY OF INVENTION

It is therefore a primary objective of the claimed invention to provide a new method and apparatus for updating firmware by examining if the new firmware code is suitable to solve the above-mentioned problem.

According to the prior art, regardless of the host end or the peripheral device end, it cannot examine whether the new program for updating firmware is suitable or not and of course it cannot prevent the peripheral device from embedding an unsuitable program code.

In accordance with the claimed invention, adding a host-end examining step/or a peripheral-end examining step in the firmware updating flow of a peripheral device by comparing part the content of the new program code with a default content to determine whether or not the new firmware code is suitable. The practical implementation, the firmware identification code (such as the vendor ID of the firmware and the model name supported by the firmware) of the new firmware code can be examined to determine if it conforms to the firmware identification code of the existed firmware code of the peripheral device. It also can inspect if the new firmware code comprises specific instructions or constants in a practical implementation. Additionally, it also can inspect if an instruction/data of a specific address is anticipated or inspect if the address of a specific instruction/data is anticipated to determine the suitability of the new firmware code. The above-mentioned inspection steps can be independently executed in the host-end and peripheral-end to ensure the new firmware code for updating is proper and to prevent the peripheral device from embedding an unsuitable firmware code.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is an allocation schematic diagram of the host and the peripheral device of a typical electronic system.

FIG. 2 is a firmware update flowchart of the electronic system in FIG. 1 according to the prior art flow.

FIG. 3 is an allocation schematic diagram of the host and the peripheral device of an electronic system of the present invention.

FIG. 4 is a firmware update flowchart of the electronic system in FIG. 3 according to the present invention.

FIG. 5 to FIG. 9 are schematic diagrams of different embodiments of the host-end/peripheral-end inspection steps of FIG. 4.

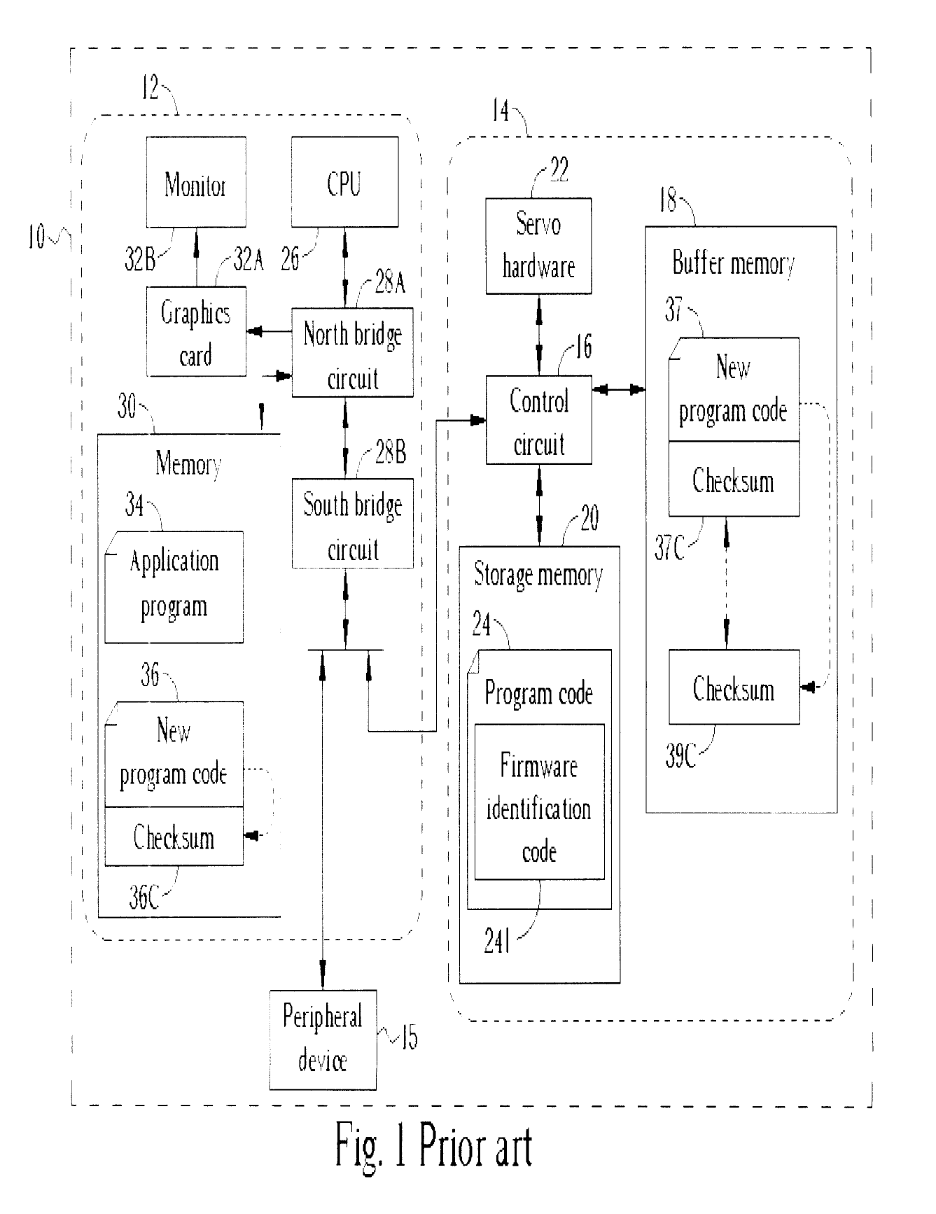

### DETAILED DESCRIPTION

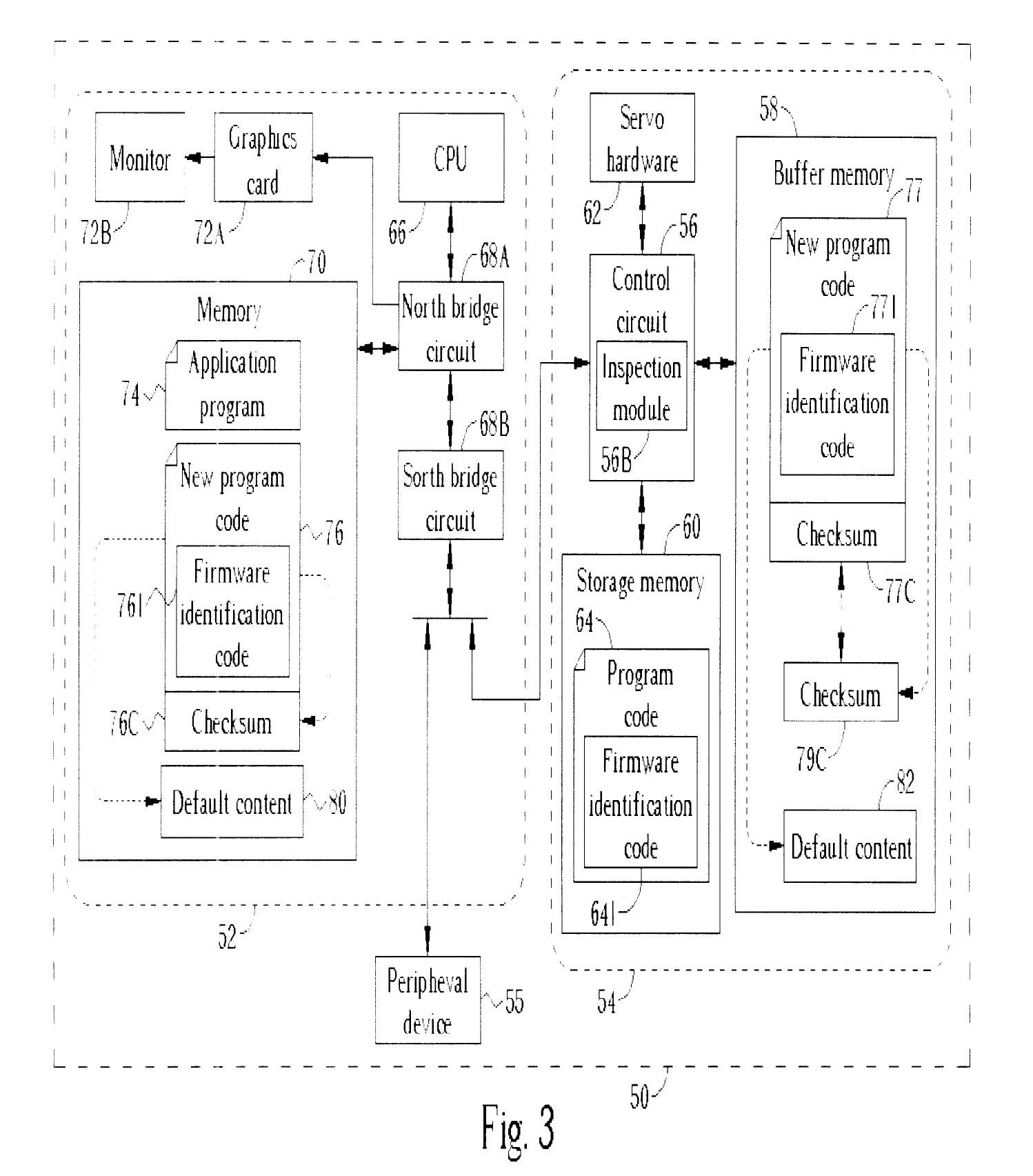

Please refer to FIG. 3. FIG. 3 is a function block diagram of an electronic system 50 according to the present invention. The electronic system 50 includes a host 52 and one or more co-work peripheral devices (FIG. 3 shows two peripheral devices 54, 55 as an example) to extend the function of the host 52. The electronic system 50 can be a computer system and in this case the host 52 comprises a CPU 66, a north bridge circuit 68A, a south bridge circuit 68B, a memory 70, a graphics card 72A and a monitor 72B. Each of the peripheral devices 54, 55 can be an optical disk drive, an optical recorder or a hard disk etc. The peripheral device 54 is an example to illustrate the allocation of the peripheral device herein. The peripheral device 54 includes a control circuit 56, a servo hardware 62 for implementing functions of the peripheral device 54, a buffer memory 58 for temporarily storing data by using volatile method (such as a random access memory) and a storage memory 60 for storing data by using a non-volatile method (such as flash memory). The control circuit 56 includes an inspection module 56B. In the host 52, the CPU 66 is used for controlling operations of the host 52; the graphics card 72A transforms the operational states and results of the host 52 into images on the monitor 72B. The volatile memory 70 (such as a random access memory) is used to temporarily store a required program code or related data of the CPU 66. The north bridge circuit 68A is used for managing data transmission between the CPU 66, the memory 70 and the graphics card 72A. The host 52 exchanges instructions and data with the peripheral devices 54, 55 via the south bridge circuit 68B electrically connected to the north bridge circuit 68A. The south bridge circuit 68B connects with each of the peripheral devices through buses (such as IDE bus, EIDE bus and so on). As mentioned above, in order to control the peripheral device 54 to execute various operations, a firmware code is also used to record implementing methods of each control procedures. The existing program code 64 stored in the storage memory 60 is the firmware code. After the control circuit 56 receives the control instructions transmitted from the host 52, the program code 64 stored in the storage memory 60 is executed to control the servo hardware 62 to implement functions requested by the host 52. The buffer memory 58 is used for temporarily storing required data of the peripheral device 54. For example, if the peripheral device 54 were an optical recorder, the servo hardware 62 comprises a motor, a pick-up head and other components. The data which host 52 purposes to write into an optical disk is temporarily stored in the buffer memory 58 and servo hardware 62 then writes the data stored in the buffer memory 58 into the optical disk. The data retrieved by servo hardware 62 is also temporarily stored in the buffer memory 58 and the control circuit 56 then arranges to transmit the data to host 52.

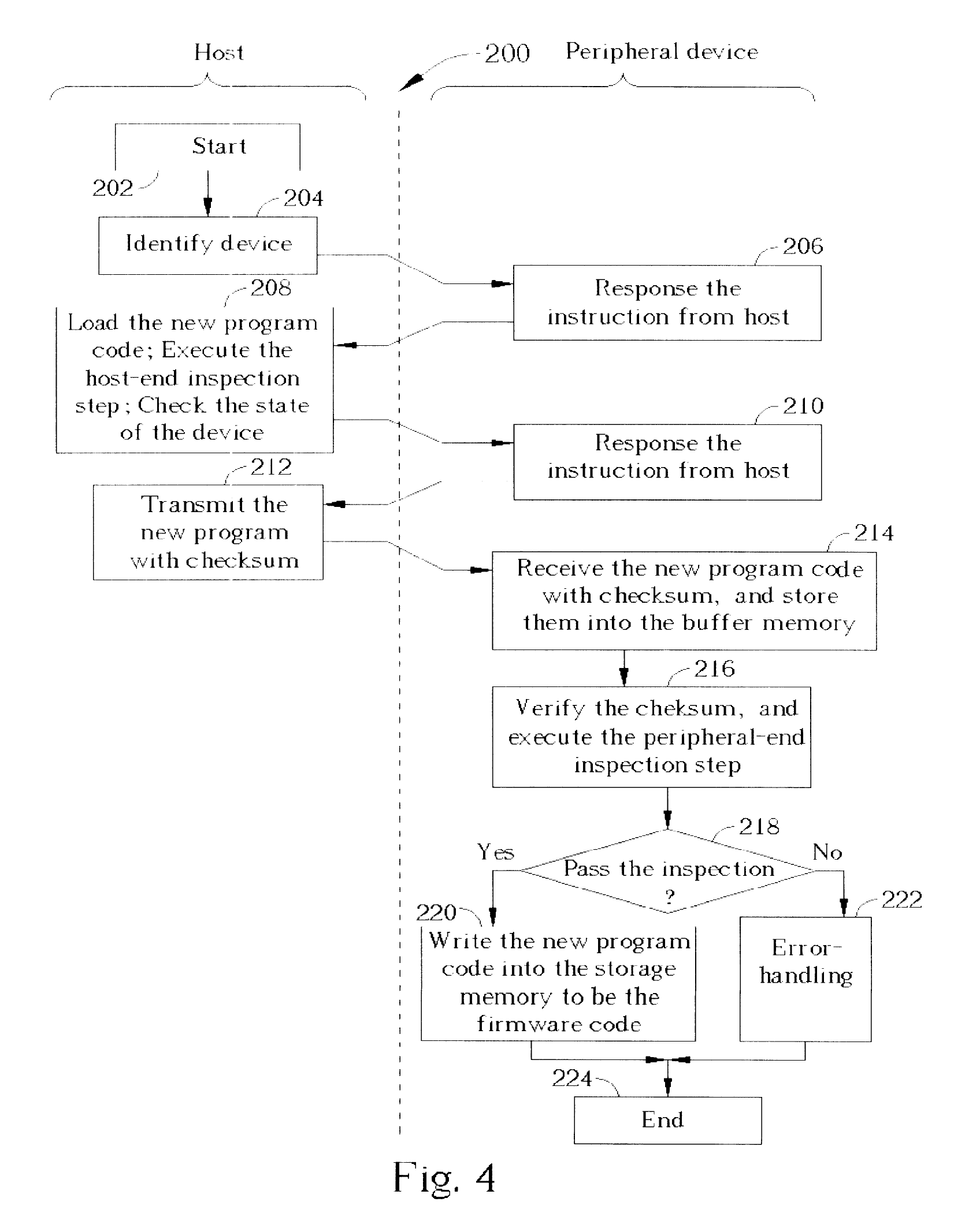

As discussed above, there is a demand to keep the firmware of a peripheral device updated. Please refer to FIG. 4, as well as FIG. 3. FIG. 4 shows the flow 200 of firmware updating in the electronic system 50 according to the present invention. The host 52 executes the steps of the left side of FIG. 4 and the peripheral device 54 executes the steps of the right side of FIG. 4. The flow 200 comprises the following steps:

Step 202: Start. When the electronic system 50 updates the firmware of the peripheral device 54, the CPU 66 of the host 52 loads an application program 74 for firmware updating into the memory 70 (please refer to FIG. 3), then starts to execute the application program 74 to start the firmware updating flow 200 and continuously controls the updating flow in the following steps. The purpose of updating the firmware is to replace the existed firmware code 64 of the peripheral device 54 with a new program code 76 in host 52.

Step 204: Host 52 identifies the peripheral device 54. As it is mentioned above, the firmware code of each peripheral device has a firmware identification code record, a vendor ID of the firmware and model names of the peripheral device supported by the firmware. As shown in FIG. 3, program code 64 in the peripheral device 54 also records a corresponding firmware identification code 641. When the host 52 identifies the peripheral device 54, host 52 sends a control command to request the peripheral device 54 to return related information of the firmware identification code 641 in order to ensure that the application program 74 conforms to the peripheral device 54, so that the application program 74 co-works with the peripheral device 54 in following the updating steps.

Step 206: After the control circuit 56 of the peripheral device 54 receives the control command transmitted from host 52 in step 204, the peripheral device 54 returns information of the firmware code 64 related with the firmware identification code 641 to the host 52.

Step 208: Host 52 can determine if the application program 74 conforms to the peripheral device 54 according to the data related to the firmware identification code 641, which should be returned from the peripheral device 54. If the host 52 confirms that the application program 74 indeed conforms to the peripheral device 54, the host 52 continues executing the application program 74 and proceeds with the update. In the meantime, the CPU 66 loads the new program code 76 and updates the firmware into the memory 70 as shown in FIG. 3. In the device identification process, the host 52 and the peripheral device 54 exchange data several times. For brevity, further details are omitted in FIG. 4.

In order to further ensure the content of the new program code 76 it conforms to the peripheral device 54. The present invention does not execute device identification, but it executes an extra host-end inspection to determine if the new program code 76 is suitable. There are several ways to do the host-end inspection. For example, because the new program code 76 is a firmware code, it must record a firmware identification code 761 (please also refer to FIG. 3) just like the program code 64 of the peripheral device 54 had a corresponding firmware identification code 641. In this host-end inspection step, the host 52 checks the firmware identification code 761 of the new program code 76 and determines if it conforms to the firmware identification code 641 of the existing program code 64. The Host 52 can verify if the new program code 76 developed by the same vendor of the existing program code 64 in the peripheral device 54 or if the new program code 76 supports the peripheral device of the same model name. Additionally, the firmware vendor can pre-record default control instructions, strings or data in a specific address of the firmware code to form a default content 80 (see FIG. 3). When host 52 executes the host-end inspection steps, host 52 determines the suitability of the new program code 76 by checking if default content 80 is recorded in the specific address of the new program code 76. The host 52 also can determine the suitability of the new program code 76 by checking if the address recorded the default content of the new program code 76 conforms to the default address set by the firmware vendors. The details of the host-end inspection steps will be discussed later.

If host 52 determines the new program code 76 is suitable and correct after the host-end inspection steps executedit can continue running the firmware updating flow. The host 52 sends an instruction to query the peripheral device 54. The instruction tests if the state of the peripheral device 54 is capable of executing firmware updates.

Step 210: The peripheral device 54 responds to the query of the host in step 208 and returns the state of the peripheral device 54 to the host 52.

Step 212: The host 52 receives the signal respond from the peripheral device 54. If the peripheral device 54 is at a state capable of executing firmware updates, the host 52 transmits the new program code 76 stored in the memory 70 to the peripheral device 54. Such like the device identification in step 204 and step 206, the host 52 and the peripheral device 54 may exchange data several times for examining the state of the peripheral device 54 in step 210 and step 212. For brevity, further details are omitted in FIG. 4. As shown in FIG. 3, the host 52 utilizes a default checksum-generation algorithm for generating a checksum 76C according to the content of the new program code 76 before it transmits the new program code 76 to the peripheral device 54. The checksum 76C then attaches to the checksum 76 and is transmitted to the peripheral device 54 together with the checksum 76.

Step 214: The peripheral device 54 receives the new program code and the attached checksum transmitted from the host 52 and temporarily stores them into the buffer memory 58. The program code and the checksum temporarily stored in the buffer memory 58 are also the new program code 77 and the checksum 77C of FIG. 3.

Step 216: The control circuit 56 of the peripheral device 54 utilizes the checksum-generation algorithm to generate a checksum 79C according to the content of the new program code 77 (see FIG. 3) and it examines if the checksum 79C conforms to the checksum 77C transmitted from the host 52 to the peripheral device 54. If the two checksums are identical, it shows that no transmission error occurs while the host 52 transmits the new program code to the peripheral device 54.

After ensuring that the new program code for updating firmware is completely transmitted from the host 52 to the peripheral device 54, according to the present invention, the peripheral device 54 further executes a peripheral-end inspection step. So that the control circuit 56 implements functions of the inspection module 56B by checking whether the new program code 77, temporarily stored in the buffer memory 58, is suitable or not. For example, the control circuit 56 is capable of comparing the new program code 77, temporarily stored in the buffer memory 58, with the existing program code 64 stored in the storage memory 60 to determine if the two program codes have the same firmware identification code. Since the new program code 77 is transmitted from the host 52, if no transmission error occurs, the new program code 77 and the firmware identification code 76I have the same firmware identification code 77I. The control circuit 56 can determine if the new program code 77 conforms to the peripheral device 54 by comparing the firmware identification code 77I with the firmware identification code 64I of the existing firmware code 64. Similar to the host-end inspection step, the peripheral-end inspection step executed by the peripheral device 58 is also capable of examining if the content of the default specific address of the new program code 77 conforms to a default content 82 (as shown in FIG. 3). The peripheral-end inspection step is also capable of searching for a specific content in the new program code 77 or checking if the specific content is located at a specific address. The details of the peripheral-end inspection steps, according to the present invention, will be discussed later.

If the control circuit 56 finds that the checksum 77C does not conform to the checksum 79C, generated by the control circuit 56, before it executes the peripheral-end inspection steps, according to the present invention, a data transmission error occurs when the host 52 transmits the new program code to the peripheral device 54. At this time the peripheral device 54 can return the error to the host 52 or request the host 52 to re-transmit the new program code till the new program code is completely transmitted to the peripheral device 54 and the peripheral-end inspection steps then continue.

Step 218: After the control circuit 56 executes peripheral-end inspection steps and the new program code 77 is confirmed that it conforms to the peripheral device 54, then go to the step 220, otherwise go to the step 222.

Step 220: After it passed the checksum examination and the peripheral-end inspection steps, the peripheral device 54 ensures receiving the new program code 77 transmitted from the host 52 correctly. It also ensures that the new program code 77 conforms to the peripheral device 54. At this time the control circuit 56 replaces the program code 64 with the new program code 77 by erasing the former firmware code, the program code 64, stored in the storage memory 60. It then writes the new program code 77 into the storage memory 60 and thereby completes the firmware update. Next the control circuit 56 is capable of executing the new program code 77, which is stored in the storage memory 60, to control operations of the peripheral device 54 with new control procedures. Certainly, after the firmware updated, peripheral device 54 can report the completed firmware update result to the host 52. The host 52 can further request the peripheral device 54 to return related information of the firmware identification code in the new program code for ensuring the firmware is updated. For brevity, the details are omitted in FIG. 4.

Step 222: If the new program code 77 is found not suitable in the peripheral-end inspection step 216, according to the present invention, the control circuit 56 has to handle the error. The control circuit 56 can return the result that the new program code is not suitable to the host 52 so that the user should determine what further steps to take. At this time, the control circuit 56 does not rewrite the unsuitable new program code into the storage memory 60. The control circuit 56 does not control the peripheral device 54 with the unsuitable new program code. In the following process, the unsuitable new program code does not effectively operate of the peripheral device 54 either.

Step 224: End of firmware updating flow.

As foregoing illustration of the firmware updating flow explains, in the flow 200 of the invention, the invention not only executes device identification and checksum confirmation but also executes the host-end inspection steps and peripheral-end inspection steps. The former examines if the new program code 76 for updating firmware conforms to the peripheral device 54 before the host 52 transmits the new program code 76 to the peripheral device 54. After the new program code 76 transmitted to the peripheral device 54 successfully and becomes the new program code 77, the peripheral device 54 further executes a peripheral-end inspection step to determine if the new program code 77 conforms to the peripheral device 54 before the new program code 77 is written into the storage memory 60. By executing the host-end/peripheral-end inspection steps according to the invention, the firmware updating flow can be further ensured so that unsuitable firmware code will not be embedded into the peripheral device. The following elaborates several embodiments of the host-end/peripheral-end inspection steps.

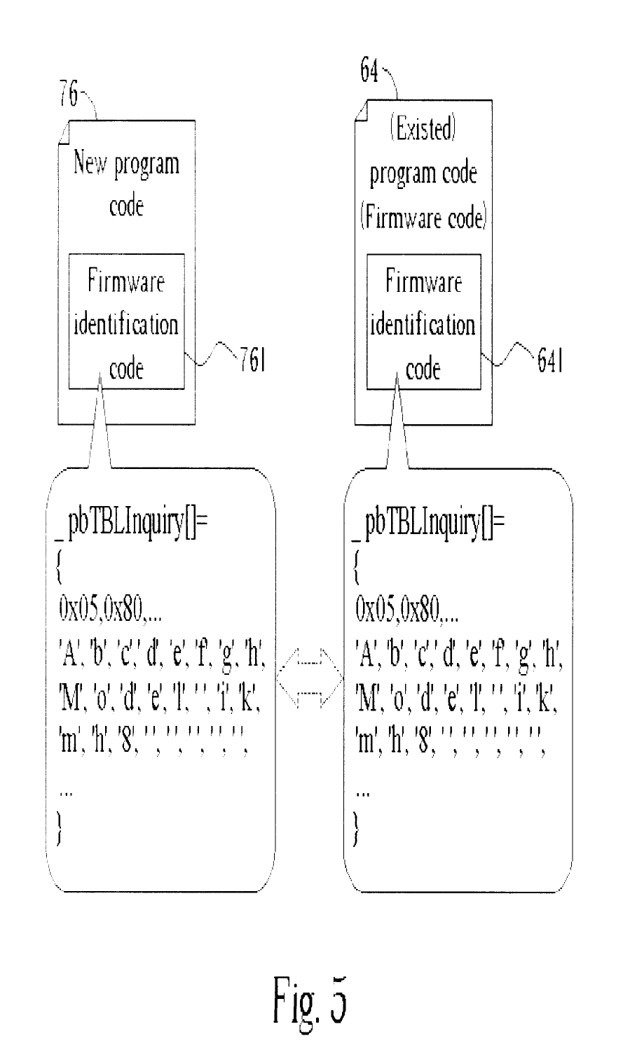

Please refer to FIG. 5 as well as FIG. 3: FIG. 5 is a schematic diagram of an embodiment of the host-end/peripheral-end inspection steps according to the invention. As mentioned above, the firmware vendor defines some information of the firmware such as the vendor ID, model names of peripheral devices supported by the firmware code, serial number and the version of the firmware code in the firmware code in order to form a firmware identification code. The information is recorded in different versions of firmware code. As shown in FIG. 5, regardless the existing firmware code 64 of the peripheral device 54 before the firmware or the new program code 76 and 77 is updated, each of them has the same firmware identification code, which needs to conform to the peripheral device 54. In general, related signals of the firmware identification code are recorded in a constant of the firmware code. As this is well known in the art, the firmware vendor codes control procedures of the peripheral device to a source code with a higher-level program language, a compiler then compiles the source code to generate an executable binary program code for the control circuit of the peripheral device. The firmware vendor often uses a constant array _pbTBLInquiry[ ] to compile the content of the firmware identification code in the firmware source code. The content can be directly represented in a value such as 0x05 or be edited with characters. For example, an ‘A’, represents an ASCII code, which is compiled by the compiler to be a binary firmware code that is executable for the control circuit of the peripheral device and then stored in the firmware code with a binary constant. Therefore, it must a part of the content of the firmware code, which is used for defining the constant. In the firmware identification code 64I of the existed program code 64 of FIG. 5 for example, part of content of the firmware identification code 64I is binary definition of the constant _pbTBLInquiry such as (0x05, 0x80, . . . ,‘A’,‘b’, . . . ,‘d’,‘M’, . . . ,‘k’,‘m’, . . . ,‘ ’, . . . ), wherein “Abcdefgh” represents the vendor ID, “Model ikmh” represents model name and the other data can be used for representing other information such as the version of the firmware code. Similarly, if the new program code 76 for updating firmware is a suitable firmware code, it must have a firmware identification code 761 used for defining the value of the constant _pbTBLInquiry[ ]. When the host-end inspection step executes, the host 52 executes the application program 74 (see FIG. 3) to update the firmware. The host 52 searches the new program code 76 to examine if part of the content of the new program code 76 is used for defining the constant _pbTBLInquiry as a specific value. At this time, the host 52 can further request the peripheral device 54 to return the value of the constant _pbTBLInquiry of the existed program code 64. Definitely, if the new program code 76 has no definition of the constant that represents the new program code 76, it is not a suitable firmware code. If the new program code 76 indeed has a definition of the constant and it conforms to the definition within the existed program code 64 (such as both have the same vendor ID and model name), the host 52 is capable of determining if the new program code 76 is suitable in the host-end inspection step. Additionally, in the host-end inspection, the host 52 can further determine if a newer version exists for the new program code 76, than the existing program code 64. If the version of the new program code is older, the host 52 can determine that the new program code is unsuitable. In order to extend the comparing concept, the present invention can also check if the value of a constant in the new program code is within a specific range. In the above-mentioned example, the version information of the new program code is checked to determine whether it is greater than that of the existed program code or not.

The host-end inspection compares the firmware identification code 76I of the new program code 76 with the firmware identification code 64I of the new program code 64, the firmware vendor can record the proper format and value (or a reasonable range of the value) of the constant _pbTBLInquiry in the application program 74 when the application program 74 is released. When the host 52 executes the host end inspection by executing the application program 74, the host 52 determines if the new program code is suitable according to the required conditions of the constant _pbTBLInquiry in the application program 74 instead of the information of the firmware identification code 641. The control circuit 56 of the peripheral device 54 can also utilize the definition of the constant _pbTBLInquiry in the existing program code 64 to check if the new program code 77, temporarily stored in the buffer memory 58, is suitable for the peripheral-end inspection. Similarly, when the peripheral device 54 is produced, the firmware vendor can also pre-set a proper standard, content value or reasonable range of the content value (such as the version number should be greater than a default value) into the control circuit 56. So that in the future when the control circuit 56 executes the peripheral-end inspection, the new program code 77 can determine its suitability by simply checking if it has a correct definition of the constant _pbTBLInquiry. In the information industry, adding the firmware identification code into the firmware code is a standard method and the present invention can simply use the firmware identification code to determine whether the new firmware code for updating firmware is suitable or not.

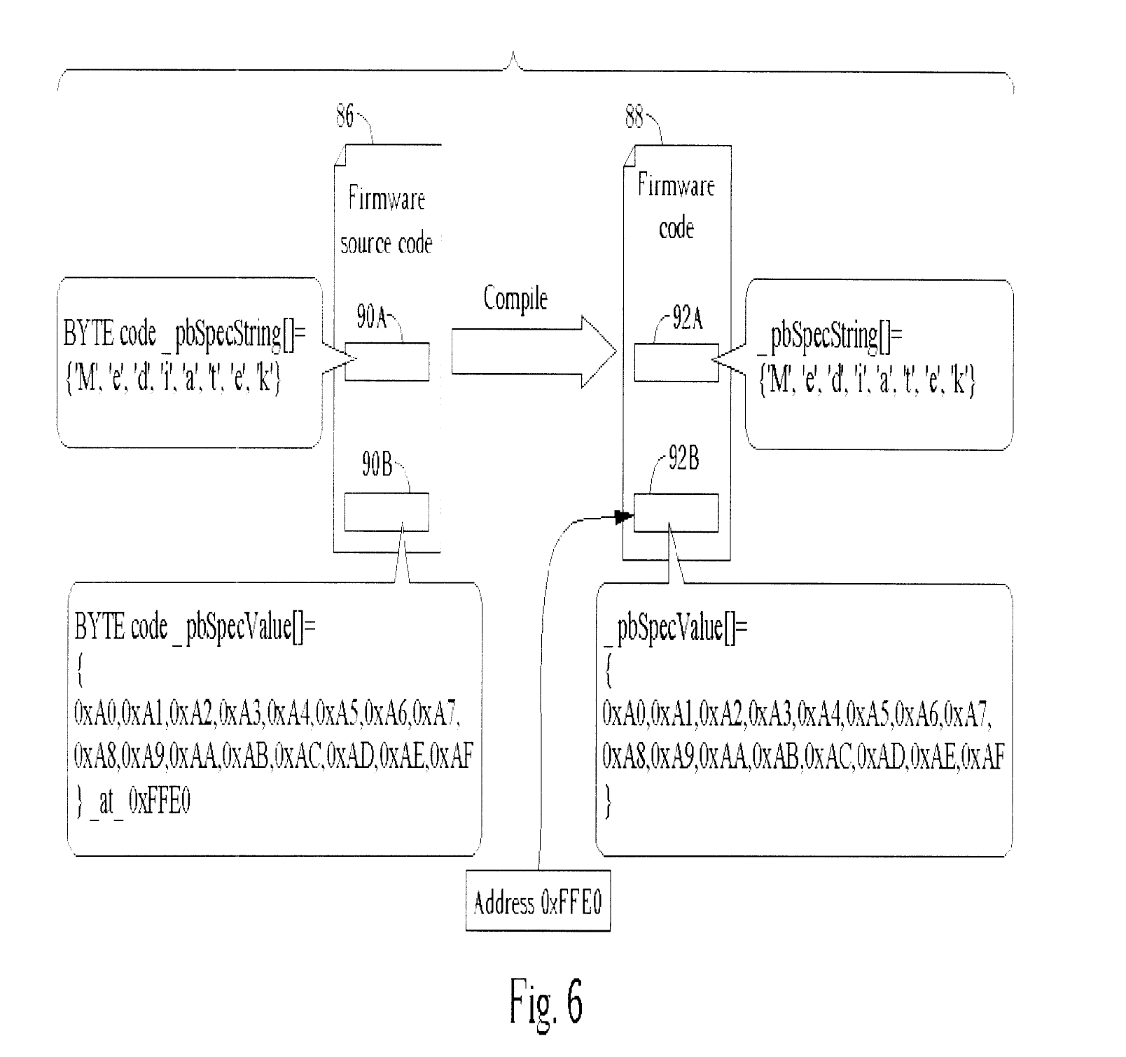

Please refer to FIG. 6 as well as FIG. 3. FIG. 6 is a schematic diagram of another embodiment of the host-end/peripheral-end inspection steps of the invention. Except utilizing the common defined firmware identification code in the firmware code to determine the suitability of the firmware code, the firmware vendor can also pre-insert strings or data with specific definition into the firmware code for future suitability examinations of the firmware code. As it is well known in the art, the firmware vendor codes control procedures of the peripheral device into a higher-lever program language source code, a compiler then compiles the source code to generate an executable binary program code for the control circuit of the peripheral device. The firmware vendor can use a constant array _pbTBLInquiry[ ] to compile a string or data with specific definitions. The content of the constant can be directly represented in a value such as 0x05 or be edited with characters. For example, an ‘A’, represents an ASCII code, as it is well know in the art. The compiler compiles this binary firmware code that is executable for the control circuit of the peripheral device and then stores it in the firmware code with a binary constant. As shown in FIG. 6, the firmware vendor adds two additional program sections 90A and 90B in the firmware source code 86 for respectively defining a string _pbSpecString (the content is ‘M’,‘e’,‘d’,‘i’,‘a’,‘t’,‘e’,‘k’) and a constant _pbSpecValue. Note that the program section 90 does not only define the value of the constant _pbSpecValue but also indicates that the constant should be located at a specific address 0xFFE0 (the hexadecimal address FFE0) by using an instruction “_at_{—}1xFFE0.” And the compiler places the constant in the specific address based on the instruction. After the source code 86 is compiled to a binary firmware code 88, the firmware code 88 must have a section 92A. That corresponds to the program section 90A of the source code 86, for recording the definition of the string _pbSpecString with binary code. From the address 1xFFE0 of the firmware code 88, the firmware code 88 must have a section 92B that corresponds to the program section 90B and records the definition of the constant _pbSpecValue with binary code. The firmware code 88 becomes a new program code (such like the new program code 76 of FIG. 3) for updating firmware after it is released. The host-end/peripheral-end inspection steps can be implemented by utilizing the string and constant with specific definitions. For example, when the host-end/peripheral-end inspection steps are executed, the host 52 checks if the new program code 76 records a string “Mediatek” to define the string _pbSpecString and the control circuit 56 checks if the new program code 77 records a string “Mediatek” to define the string _pbSpecString. The suitable new program code released from the firmware vendor must be part of the content used to record the string “Mediatek” to define the string _pbSpecString. If no string “Mediatek” is found of the new program code in the host-end/peripheral-end inspection steps, it represents the new program code as unsuitable. Similarly, when it executes the host-end/peripheral-end inspection steps, the host 52 and the control circuit 56 can check a correct definition of the constant _pbSpecValue located at the address 1xFFE0 in the new program codes. If there no correct definition of the constant _pbSpecValue located at the address 1xFFE0 in the new program code, it represents that the new program code is unsuitable. Furthermore, when the host-end/peripheral-end inspection steps are executed, it can check a definition of the constant _pbSpecValue located at the specific address 1xFFE0 in the new program code. In order to implement the host-end/peripheral-end inspection steps of the invention, the firmware vendor has to pre-set the control circuit 56 (see FIG. 3) before the peripheral device 54 is produced so that the control circuit 56 knows the comparing target (like the default content 82 of FIG. 3, for example, to find a string “Mediatek” in the new program code or a specific value should be located at a specific address of the new program code) once it needs to execute the peripheral-end inspection step in the future. Similarly, the firmware vendor has to prerecord the comparing target of the host-end inspection step into the application program 74 so that the host 52 follows the above-mentioned principle to execute the host-end inspection steps after the host 52 executes the application program 74.

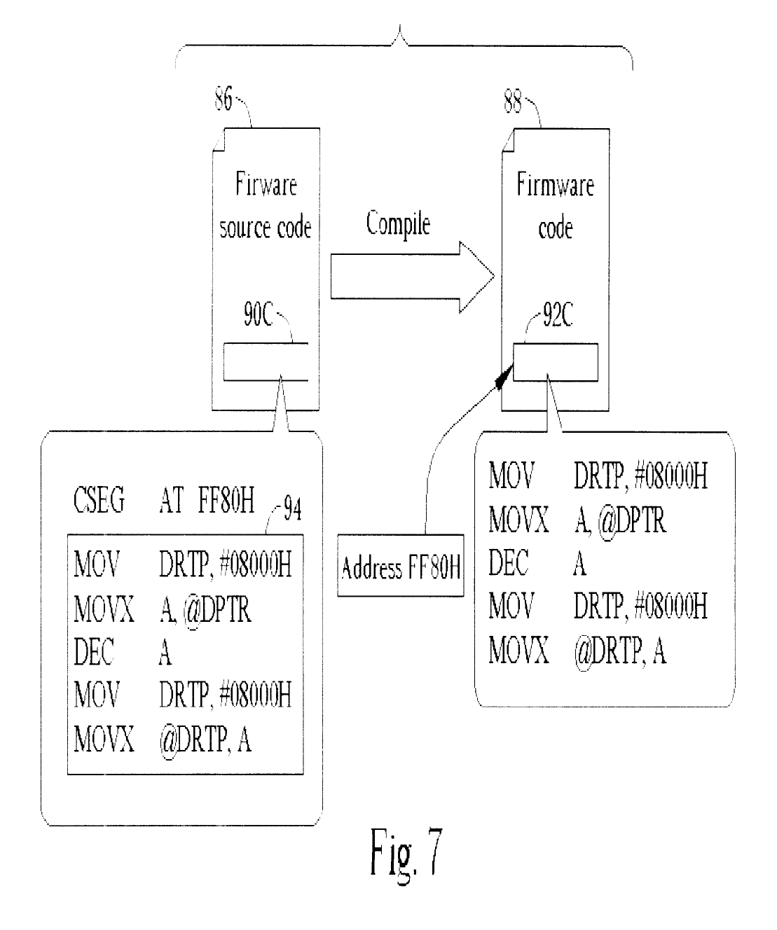

Please refer to FIG. 7. FIG. 7 is a schematic diagram of another embodiment of the host-end/peripheral-end inspection of the invention. Utilizing the constant string with specific definitions to implement the inspection steps of the present invention, a specific instruction of the firmware code can be used to implement the inspection steps of the invention. As shown in FIG. 7, when the firmware vendor codes the firmware source code 86, a program section 90C can be added into the source code and then utilize instruction “CSEG AT FF80H” for compiling a default instruction code 94 to an address FF80H (it is also the hexadecimal address FF80). The definition of the instruction code 94 can mean a control procedure with practical usage or some redundancy operations (for example, the exchange value of two variables again). As the instruction code 94 of FIG. 7, a first-line instruction, “MOV DRTP,#0800H,” is used for making a pointer DRTP to point at an address 0800H (it is also the hexadecimal address 0800) of a external memory; a second-line instruction, “MOVX A,@DRTP,” is used for moving a value to register A from the address where the pointer DRTP points at. The firmware code 88 is compiled from the source code 86. According to the indication address FF80H in the program section 90C, the firmware code 88 records the instruction code 94, which starts at the address FF80H in the section 92C, with binary code. After the firmware code 88 releases the new program code to update the firmware, the host-end/peripheral-end inspection step of the invention determines if the new program code has section 92C in correspondence to the instruction code 94 located at the address FF80H (or if the section 92C starts at address FF80H). Similar to the embodiment of FIG. 6, the application program 74 and the control circuit 56 require a pre-set comparable target (such as a specific address or a binary code corresponding to instruction code 94) for future examination in the host-end/peripheral-end inspection steps.

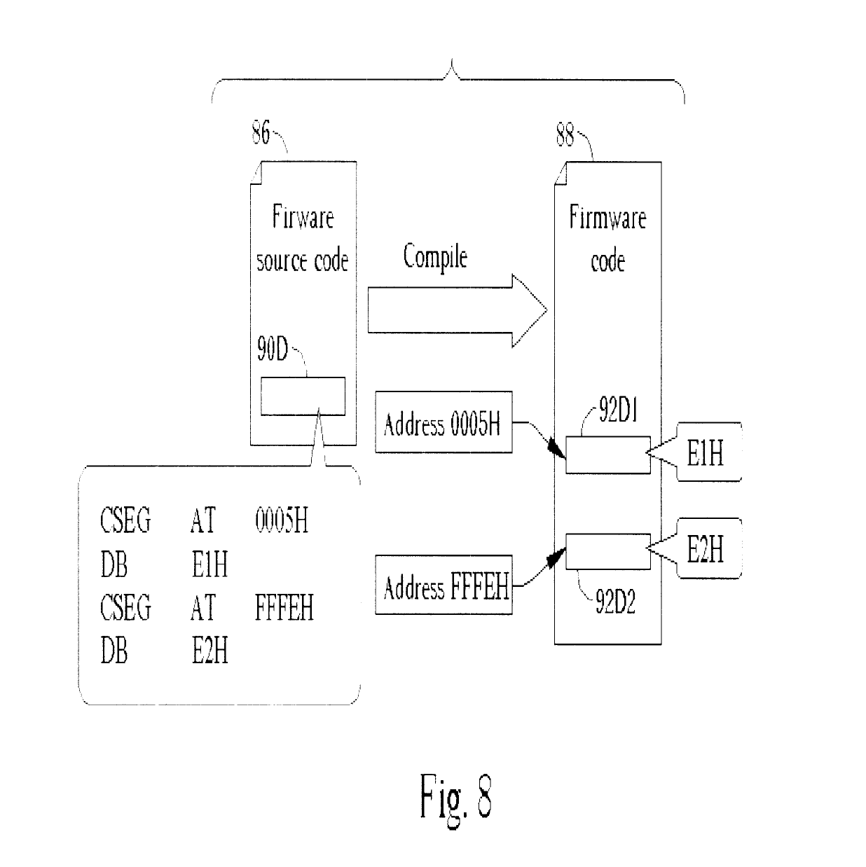

Please refer to FIG. 8. FIG. 8 is a schematic diagram of another embodiment of the host-end/peripheral-end inspection step of the invention. As shown in FIG. 8, the firmware vendor adds a program section 90D into the firmware source code 86 to add a specific value to a specific address after it is compiled. For example, in the program section 90D of FIG. 8 an instruction “CSEG AT 0005H” and an instruction “DB E1H” are used to record a byte data (its content is a hexadecimal value E1) at an address 0005H (it is also the hexadecimal address 0005) of the firmware code 88. An instruction “CSEG AT FFFEH” and an instruction “DB E2H” in next line are used to record a byte value E2 at address FFFEH. The firmware code 88 is compiled from the source code 86. After this, the firmware code 88 records the hexadecimal value E1 in the section 92D1 at the address 0005H with binary codes and records the hexadecimal value E2 in the section 92D2 at the address FFFEH with binary code.

When the host-end/peripheral-end inspection step executes, the new program code can be checked for a specific value recorded at a specific address (for example, if the value E1 is located at the address 0005H) to determine if the new program code is released from the firmware vendor.

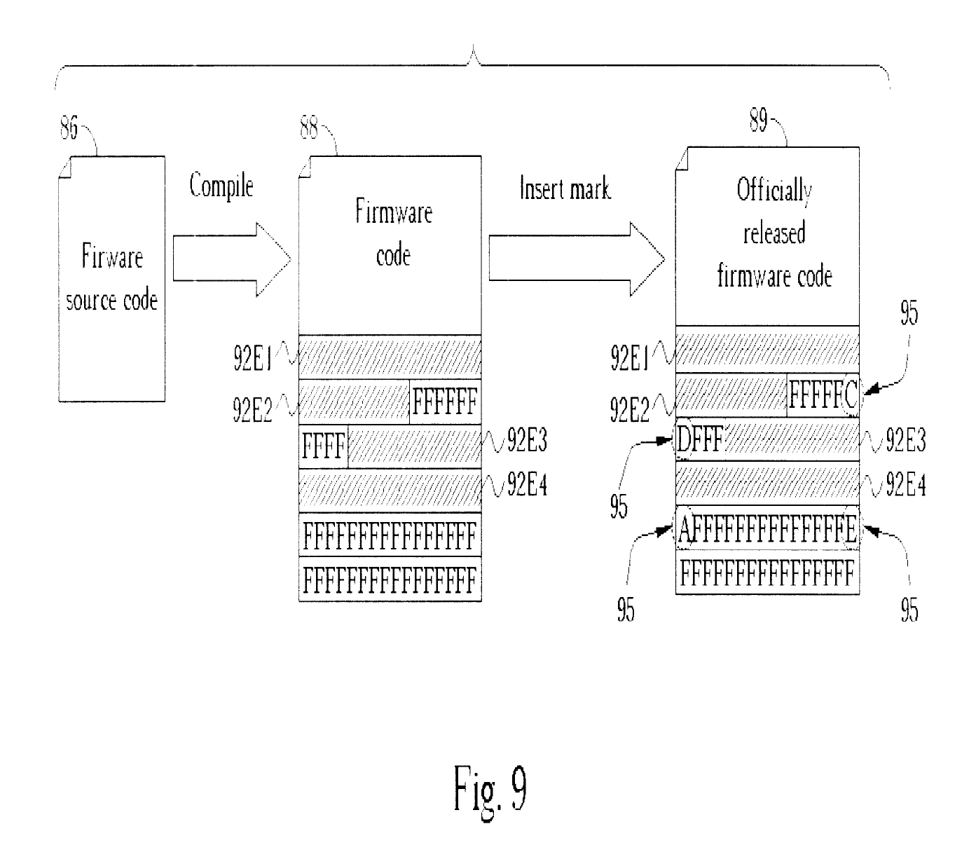

Please refer to FIG. 9. FIG. 9 is a schematic diagram of another embodiment of the host-end/peripheral-end inspection steps of the invention. Except inserting specific data or instruction into the program section of the source code to determine the suitability of the new program code, the present invention can further insert a specific data into the compiled firmware code to implement the inspection steps. As shown in FIG. 9, in general, after the source code 86 is compiled to be the firmware code 88, the firmware 88 does not only have sections record instructions or data but also has some unused segments. The unused segments will be filled with specific filling data. In FIG. 9, parts of the contents marked with oblique lines, from section 92E1 through 92E4, record binary codes and correspond to the programs or instructions. The marked sections are called code segments. Other sections filled with the hexadecimal ‘F’ are called unused segments and are without any record of program or instruction. For example, an unused segment is between the section 92E2 and section 92E3. Furthermore, since the firmware code 88 is often compiled to be a program code with fixed space (for example: 512 Kbytes) so that it can be conveniently recorded in the storage memory of the peripheral device. Therefore, it is always the firmware that has some unused segments. When the control circuit of the peripheral device executes the firmware code, it jumps between each code segment to retrieve instructions and does not execute the unused segments. So the present invention can insert specific data into the unused segment of the firmware code 88. This does not affect the peripheral device that executes the firmware code. As shown in FIG. 9, after several data 95 is inserted into the firmware code 88, the firmware code 88 becomes the officially released firmware code 89. When it executes the host-end/peripheral-end inspection step of the invention, the suitability of the new program code can be determined by searching the inserted data located at the specific address of the unused segments. Similar to the embodiments of FIG. 6 through FIG. 8, the firmware vendor also has to pre-set the application program 74 to update the firmware and the control circuit 56, such that the host 52 and the peripheral device 54 know the comparing target data located at the specific address of the unused segment. Compared with the embodiment of FIG. 9 that inserts mark data in the unused segments, the embodiments of FIG. 5 through FIG. 8 store the specific data in the code segments.

In addition to the above-mentioned embodiments, the host-end/peripheral-end inspection steps also hold the following implementations: For example, when the inspection steps are executed it searches the address of a specific data (such as a string or a constant) and generates a new address by shifting the address of the specific data with a default address. Then it checks if the content of the new address conforms to another default content. In other words, before it releases the firmware code, the firmware vendor not only needs to add indicated data into the program code but also needs to add the default content at the shifted address. Additionally, different constants at different addresses of the new program code can be operated to determine whether or not the operated value equals a default value. For example, two constants at different addresses of the new program code can be summed to determine if the sum equals a default value. As it is mentioned above, the inspection step can check the version number of the firmware in the firmware identification code to determine the suitability of the firmware code. But a violator may change the version number of the firmware and the firmware code. In order to solve the above-mentioned problem, the firmware vendor can also pre-set a checking constant at another default address of the new program code. The sum of the checking constant and the version number of the firmware in the new program code is a default fixed value. In other words, in the program code with a newer version (it is also a larger version number), the checking constant is smaller. When the host-end/peripheral-end inspection steps are executed, the host/the peripheral device checks if the version number of the new firmware is greater than that of the existing firmware. Furthermore, it also checks if the sum of the checking constant and the version number recorded in the new program code is the default value. In this way, the correctness of the version number of the firmware is checked again.

As it is mentioned before, the host-end/peripheral-end inspection step can search two addresses of two data with default content and then check if the program code between the two addresses have a default characteristic. For example, before the firmware vendor releases the suitable firmware code, a series value can be recorded between two default contents and the sum of the series value is a fixed value (or follows an increasing rule or a decreasing rule). Possibly a default value can be obtained when a default algorithm operates the series data between the two default contents. Therefore, the host and peripheral device is capable of checking if the series data between two default contents of the new program code conforms to a default rule or if a default value can be obtained after operating the series of data with a default algorithm. In accordance with the method, the firmware vendor is capable of adding different data between two data with default content into different versions of firmware code. A standard value can be obtained after operating the series added data with a default algorithm. It is therefore the present invention that can prevent the comparing rule from exposing in the program code. The series added data between the two default contents are different between firmware codes with different versions. Therefore, it is not possible to conclude a specific rule to avoid the inspection steps of the invention by analyzing firmware codes with different version.

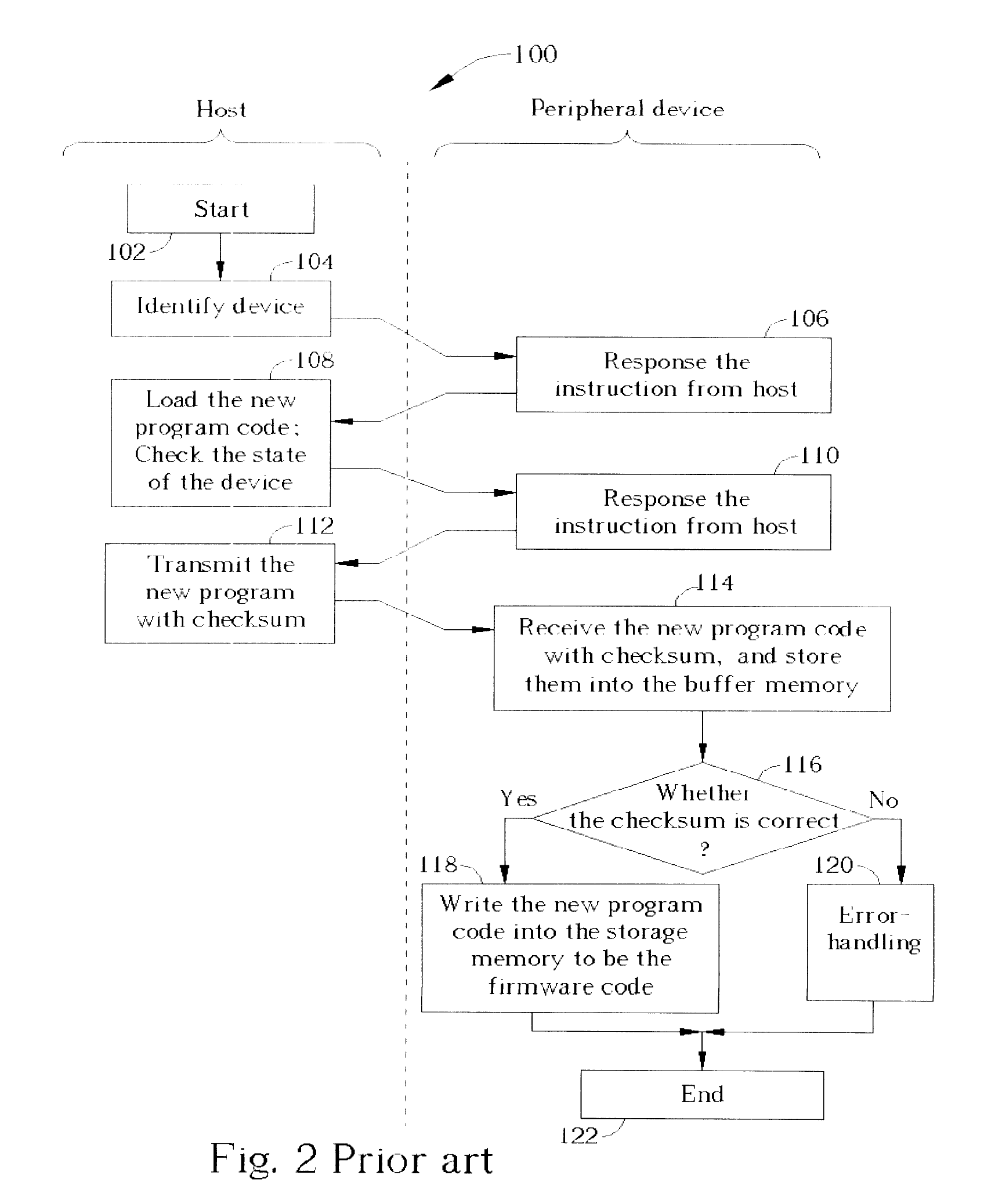

Foregoing illustrations of the host-end/peripheral-end inspection steps of the present invention show how the host or the peripheral device determine the suitability of the new program code in the firmware updating flow by checking if the new program code has data with a default content (such as a string or a value) or by checking if the data located at the default address have a default content (or if the default data located at the default address). In the implementation of the present invention (especially the embodiments of FIG. 6 to FIG. 9), the firmware vendor sets the overall strategy of the host-end/peripheral-end inspection step. Before the peripheral device is produced and before the application program for firmware update is released, the firmware vendor pre-sets the comparing target in the host-end/peripheral-end inspection step. The firmware vendor also has to add corresponding comparing data into the firmware code when it releases firmware code for future firmware update. In this way, when the peripheral device needs to update the firmware, the suitable firmware code released from the firmware vendor is ensured to pass the host-end/peripheral-end inspection steps. On the other hand the unsuitable firmware code is not possible to be embedded into the peripheral device of the firmware updating flow. When the comparing target for the control circuit 56 of the peripheral device 54 is set, the control circuit 56 operates according to the existing program code. This way the comparing target and the operational flow of the peripheral-end inspection steps can be recorded in the pre-set firmware code of the peripheral device 54. When implementing the present invention, each of the embodiments of FIG. 5 to FIG. 9 can work independently and several embodiments can also work together. Different comparing target can be used in the host-end/peripheral-end inspection steps. For example, the host 52 utilizes the embodiment of FIG. 6 in the host-end inspection steps to determine whether the new program code has the specific string. The control circuit 56 utilizes the embodiment of FIG. 5 in the peripheral-end inspection step to determine if the new program code is suitably based on the firmware identification code. In such a situation, it not only requires the firmware identification code in the suitable firmware code to implement the embodiment of FIG. 5 but it also requires a specific string to implement the embodiment of FIG. 6. The inspection base of the host-end/peripheral-end inspection step is pre-set by the firmware vendor, a precise target is obtained for checking the unsuitable firmware code. The prior art flow of FIG. 2 utilizes a checksum-generation algorithm to generate a checksum according to new firmware code for firmware updates. Compared to the present invention, the prior art does not know the corresponding checksum of the suitable firmware code so that the prior art flow cannot utilize the checksum to find out unsuitable firmware code.

Although the flow 200 of FIG. 4 of the invention show that the host-end inspection steps and the peripheral-end inspection steps are respectively executed in the host-end and peripheral-end, the present invention also supports only the host-end inspection steps executed by the host 52 or only the peripheral-end inspection steps executed by the control circuit 56. When the host-end inspection step execute, the host-end inspection steps are not necessarily limited to be executed before the device state examination, the host-end inspection steps can be executed just after the application program 74 loads the new program code. In general, only if the host-end inspection steps execute before the host 52 transmits the new program code 76 to the peripheral device 54, it can prevent the peripheral device 54 from receiving the unsuitable firmware code so that it can prevent the peripheral device from embedding the unsuitable firmware code. On the other hand, the peripheral device 54 executes the peripheral-end inspection steps to implement a final check. As it is mentioned above, if the user uses a wrong program code it can cause the peripheral device 54 to crash. If a violator (for example a hacker) provides the user with a malicious code it will be possible to crash the peripheral device 54 by utilizing the unsuitable firmware code. In accordance with the present invention, even if the unsuitable firmware code is transmitted to the peripheral device 54, the unsuitable new program code is halted in the peripheral-end inspection step executed by the peripheral device 54. With regards to the inspection module 56B (see FIG. 3) for executing the peripheral-end inspection step, it can be a real hardware circuit or its function can be implemented by utilizing the control circuit 56 for executing the existing firmware code to execute the peripheral-end inspection step. Additionally, as mentioned above, many independent work devices, such as cell phones or digital cameras, have a control circuit that executes firmware code. Usually the device works independently, but when it needs to update the firmware, the device requires a host (for example, it needs to be electrically connected to a computer via a USB cable) to get the new program code for a firmware update. The present invention can also be applied in independent devices to protect the independent devices from being embedded by unsuitable firmware code. Especially the peripheral-end inspection step executed by the device itself can actively protect the device from being embedded by the unsuitable firmware code.

In the prior art the firmware updating flow, the content of the new program code for firmware updating is not examined and therefore the prior art flow is unable to avoid the peripheral device from being embedded by unsuitable firmware code. Compared with the prior art, the firmware update flow of the present invention adds the host-end/peripheral-end inspection steps into the firmware updating flow to determine the suitability of the new program code. The content of the new program code is to stop the peripheral device from being embedded by an unsuitable new firmware code. Additionally, the present invention is helpful when integrating the firmware update flows of different peripheral devices. The present invention utilizes the host-end/peripheral-end inspection step to determine the suitability of the new program code so that a single application program can be used in the host-end and be regarded as an updating interface for different peripheral devices. That way the host can identify the type of peripheral device that is needed to update the firmware when the host executes device identification. The application program then selects the host-end inspection steps that correspond to the peripheral device to determine the suitability of the new program code obtained by the user. Different peripheral devices had build-in their own corresponding peripheral-end inspection steps to further check the suitability of the new program code which transmitted from the host. In this way, the firmware updating flows of different peripheral devices can be integrated. A single application program for firmware updates can be used to manage the firmware update of various peripheral devices, thereby the user can implement firmware update easier and more convenient.

Those skilled in the art will readily observe that numerous modifications and alterations of the device may be made while retaining the teachings of the invention. Accordingly, that above disclosure should be construed as limited only by the metes and bounds of the appended claims.

What is claimed is:

1. A method for refreshing at least a program code in an electronic system, the electronic system comprising a host device and a peripheral device, the peripheral device comprising:
a control circuit for executing a first program code to control operations of the peripheral device according to an instruction from the host device;
the method comprising:
accessing a second program code; and
executing an inspection step in the host device before the second program code replaces the first program code of the peripheral device to utilize the host device to check whether partial content of the second program code conforms to a predetermined content.

2. The method of claim 1 wherein the peripheral device further comprises a storage memory for non-volatilely storing the first program code; when the first program code is replaced by the second program code, the first program code is erased from the storage memory, and the second program code is recorded into the storage memory.

3. The method of claim 1 wherein when executing the inspection step in the host device before the second program code replaces the first program code, the inspection step is proceeded before the control circuit executes the second program code to control operations of the peripheral device.

4. The method of claim 1 wherein the predetermined content is partial content of the first program code or a constant recorded in the first program code and executing the inspection step in the host device comprises checking whether the second program code includes partial content of the first program code, or whether the constant recorded in the second program code is equal to the constant in the first program code, or whether the constant recorded in the second program code conforms to a predetermined range of the constant in the first program code.

5. The method of claim 1 wherein the predetermined content is a fixed content so that the predetermined content cannot be changed when the second program code is changed.

6. The method of claim 1 wherein when executing the inspection step in the host device, the host device will access partial content in a predetermined address in the second program code to check whether the partial content conforms to the predetermined content, or to search if the predetermined content exists in the second program code.

7. The method of claim 1 further comprising ceasing to replace the first program code with the second program code after executing the inspection step in the host device if partial content of the second program code does not conform to the predetermined content.

8. The method of claim 1 further comprising replacing the first program code with the second program code after executing the inspection step in the host device so that the control circuit can execute the second program code to control operations of the peripheral device if partial content of the second program code conforms to the predetermined content.

9. A method for refreshing at least a program code in an electronic system, the electronic system comprising a host device and a peripheral device, the peripheral device comprising:
a control circuit for executing a first program code to control operations of the peripheral device;
the method comprising:
transmitting a second program code from the host device to the peripheral device; and
executing a device inspection step, before the second program code replaces the first program code of the peripheral device, to utilize the control circuit to check whether partial content of the second program code conforms to a predetermined content.

10. The method of claim 9 wherein the peripheral device further comprises a storage memory for non-volatilely storing the first program code; when the first program code is replaced by the second program code, the first program code is erased from the storage memory, and the second program code is recorded into the storage memory.

11. The method of claim 9 wherein when executing the device inspection step before the second program code replaces the first program code, the device inspection step precedes the control circuit executing the second program code to control operations of the peripheral device.

12. The method of claim 9 wherein the predetermined content is partial content of the first program code, or a constant recorded in the first program code and executing the device inspection step comprises checking whether the second program code includes partial content of the first program code, or checking whether the constant recorded in the second program code is equal to the constant in the first program code, or checking whether the constant recorded in the second program code conforms to a predetermined range of the constant in the first program code.

13. The method of claim 9 wherein the predetermined content is a fixed content so that the predetermined content cannot be changed when the first program code is replaced by the second program code.

14. The method of claim 9 wherein when executing the device inspection step, the control circuit accesses partial content in a predetermined address in the second program code to check whether the partial content conforms to the predetermined content, or to search if the predetermined content exists in the second program code.

15. The method of claim 9 further comprising ceasing to replace the first program code with the second program code after executing the device inspection step if partial content of the second program code does not conform to the predetermined content.

16. The method of claim 9 further comprising replacing the first program code with the second program code after executing the device inspection step so that the control circuit can execute the second program code to control operations of the peripheral device if partial content of the second program code conforms to the predetermined content.

17. The method of claim 9 wherein the peripheral device further comprises a buffer for volatilely storing data; when executing the device inspection step, the control circuit temporally stores the second program code into the buffer to access partial content of the second program code and to proceed with the device inspection step.

18. The method of claim 17 wherein the peripheral device further comprises a non-volatile storage memory for non-volatilely storing the first program code; when executing the device inspection step before the first program code is replaced by the second program code, the device inspection step precedes the first program code being erased and the second program code being recorded in the non-volatile storage memory.

19. The method of claim 9 wherein the peripheral device is an optical drive.

20. A peripheral device comprising:
a control circuit for executing a first program code to control operations of the peripheral device; the control circuit comprising a checking module, the checking module being used to check whether partial content of the second program code conforms to a predetermined content before the control circuit replaces the first program code with a second program code.

21. The peripheral device of claim 20 further comprising a non-volatile storage memory for non-volatilely storing the first program code; when the first program code is replaced by the second program code, the first program code is erased from the non-volatile storage memory and the second program code is recorded into the non-volatile storage memory.

22. The peripheral device of claim 20 wherein when the checking module operates an examining process before the control circuit replaces the first program code with the second program code, the checking module operates before the control circuit executes the second program code to control operations of the peripheral device.

23. The peripheral device of claim 20 wherein the predetermined content is partial content of the first program code, or a constant recorded in the first program code; when the checking module operates an examining process, the checking module checks whether the second program code includes partial content of the first program code, or whether a constant recorded in the second program code is equal to the constant in the first program code, or whether the constant recorded in the second program code conforms to a predetermined range of the constant in the first program code.

24. The peripheral device of claim 20 wherein the predetermined content will not be changed when the first program code is replaced by the second program code.

25. The peripheral device of claim 20 wherein when the checking module operates an examining process, the control circuit will access partial content in a predetermined address in the second program code so that the checking module can check whether the partial content conforms to the predetermined content, or to search if the predetermined content exists in the second program code.

26. The peripheral device of claim 20 wherein if partial content of the second program code does not conform to the predetermined content, the control circuit will cease to replace the first program code with the second program code after the checking module operates an examining process.

27. The peripheral device of claim 20 wherein after the checking module ensures that partial content of the second program code conforms to the predetermined content, the control circuit replaces the first program code with the second program code so that the control circuit can execute the second program code to control operations of the peripheral device.

28. The peripheral device of claim 20 further comprising a buffer for volatilely storing data, wherein the control circuit temporally stores the second program code in the buffer and the checking module operates an examining process after the control circuit accesses partial content of the second program code.

29. The peripheral device of claim 28 being applied in an electronic system, the electronic system further comprising a host device, wherein the second program code is transmitted from the host device to the peripheral device.

30. The peripheral device of claim 28 further comprising a non-volatile storage memory for non-volatilely storing the first program code; when the checking module operates the examining process before the first program code is replaced by the second program code, the device inspection step precedes the first program code being erased and the second program code being recorded in the non-volatile storage memory.

31. A method for refreshing at least a program code in an electronic system, the electronic system comprising a host device and a peripheral device, the peripheral device comprising:
a control circuit for executing a first program code to control operations of the peripheral device according to an instruction from the host device;
the method comprising:
accessing a second program code; and
executing an inspection step before the second program code replaces the first program code of the peripheral device to generate a corresponding content characteristic according to the second program code and to check whether the corresponding content characteristic conforms to a predetermined characteristic, the predetermined characteristic being not changed when the first program code is replaced by the second program code.

32. The method of claim 31 wherein the inspection step is proceeded by the host device.

33. The method of claim 31 wherein the inspection step is proceeded by the control circuit of the peripheral device.

34. The method of claim 31 wherein the content characteristic is an address where a predetermined content is located in the second program code and the predetermined characteristic is a predetermined address; the inspection step further comprising checking whether the address where the predetermined content is located in the second program code is equal to the predetermined address.
